(19) United States
(12) Patent Application Publication
(10) Pub. No.: US 2005/0145187 A1
(43) Pub. Date: Jul. 7, 2005

(54) Asset management of livestock in an open range using satellite communications

(76) Inventor: James DeWayne Gray, Plano, TX (US)

Correspondence Address: Michael L. Diaz;MICHAEL L. DIAZ, PCC, 555 Republic Drive, Suite 200, Plano, TX, 75074, US

(21) Appl. No.: 10/749,765

(22) Filed: Dec. 29, 2003

(51) Int. Cl. A01K 29/00

(52) U.S. Cl. 119/174; 340/10.1

(57) ABSTRACT

A livestock asset management system utilizing an electronic ear tag 14 capable of operating on an open range, corral, or feedlot. The electronic ear tag 14 is capable of reading a radio frequency identification device (RFID) 24, storing that data in a processing unit in the ear tag 36, and then transmitting data to a satellite 12, which relays the information of an individual animal to a hub server 16 that appends a data record and makes that record available over a network 10 for display on a network access device such as a computer 18. An individual or group of animal records can be appended manually or semi-automatically by the livestock owner using a network interface device such as a personal computer 18. With automatic notification to livestock owner if data from the ear tag is outside a pre-defined limit 70 along with graphical displays 60 of same information.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### TECHNICAL FIELD OF THE INVENTION

The present invention relates to livestock management in an open range, corral, or feedlot and more particularly to the method and system for livestock data collection via a relay satellite and the distribution of information gathered over a public network.

### BACKGROUND OF THE INVENTION

Currently, there are a few livestock electronic monitoring systems. Generally they use passive radio tags and active readers although some have active transmitter designs for a confined area. None of these systems offers the capability of livestock monitoring in an open rang along with a globally networked accessible database.

This invention relates to a method and system that enables a livestock producer to monitor and collect data from the livestock in an open range, pasture, corral, or feedlot and to update monitored data into a global Internet accessible information base. By using this system any animal may be tracked from its conception to its consumption virtually anywhere on earth, and its history can provide source verification, quality assurance, and performance tracking.

Although it is possible to automate the identification and provide data entry at a localized level, many of those involved in the livestock production and processing cycles are not equipped with the technology necessary for automation. The primary objective of this invention is to provide an automated animal identification method and system for those non-automated entities and persons involved in the production and processing of livestock with informational records readily available via a public network such as the Internet. The present invention allows those persons and entities to identify livestock animals with electronic identification units, which are in the form of a radio frequency transponder reader within an active electronic identification radio frequency identification ear tag that communicates by satellite, to enter and collect information on that individual animal automatically and provide this information to the livestock owner from asset management over a public network. The present invention also allows for compatibility with existing livestock identification technologies so that these devices can continue to be used either independently or integrated within this data collection system.

Currently, many non-automated persons or entities do not have electronic identification transponder readers, nor do they generally have data collection software. An object of the present invention is to provide an effective automated data collection and database management methodology in the livestock industry including effective communication and sharing of data between those involved in the production, processing cycle, and regulation. One result of this data collection and management invention is that quality assurance and data source verification for individual animals will be available throughout the production cycle and universally available to multiple individuals and/or organizations via private and public network access devices. The source verification provides an opportunity for enhanced product value through improved quality assurance, food safety, and to automatically generate reports that meet the Country Of Origin Labeling (COOL) that will be mandatory after Sep. 30, 2004 according to the U.S. Department of Agriculture.

Another object of this data collection and management invention is that animal-specific performance information can be provided to the producer, the stockman, the feedlot, the packer, the buyer, and government agencies simultaneously so that those entities can make informed herd management and operational decisions. Improved information availability permits all segments of the livestock industry to reduce their cost of operations while improving product quality. The opportunities for process improvement field from avoiding duplicate vaccination treatments, rapid detection and treatment of a sick animal, selecting more cost effective breeding stock; selecting more cost effective feeds and to prevent overgrazing of pasture and range areas.

As part of the production process, other entities, which are not usually in the direct chain of title to an animal, also have an interest in a portion of the data. Veterinarians can access or update the health history, nutritionists can access the feed and health history, and bankers can determine the location of their collateral. An object of the present invention is to employ authorization levels settable by the livestock owner to designate what information may be made available to these entities.

Through the current invention, the complete history of an animal can be available throughout the production and processing cycle, and both source verification and specific performance information are accessible to multiple interested parties.

Although the invention is described in the context of beef cattle, it is not so limited. It should be apparent to those skilled in the art that the invention can be modified, without departing from its principles, for other forms of livestock.

### DESCRIPTION OF THE PRIOR ART

Electronic identification devices and systems have provided a good method for providing localized identification of livestock. Typically, electronic identification systems use a passive electronic identification device that is induced to transmit its identification signal by an externally radiating source.

The passive electronic identification devices may be a transponder carried with the individual animal on a collar as illustrated and described in Carroll U.S. Pat. No. 4,475,481, issued Oct. 9, 1984, entitled “Identification System” and in Kuzara U.S. Pat. No. 4,463,353, issued Jul. 31, 1984, entitled “Animal Feeding and Monitoring System”; in an ear tag such as those commercially available from Destron/Fearing, Inc., Allflex USA, Inc. and Avid Marketing, Inc.; in a transponder implanted in the animal as illustrated and described in Pollack U.S. Pat. No. 4,854,328, issued Aug. 8, 1989, entitled “Animal Monitoring Telltale and Information System” and in Hanton U.S. Pat. No. 4,262,632, issued Apr. 21, 1981, entitled “Electronic Livestock Identification System”; or in a bolus such as illustrated and described in U.S. Pat. No. 4,262,632, issued Apr. 21, 1981, entitled “Electronic livestock identification system” by John P. Hanton and Harley A. Leach; a multitude patents U.S. Pat. Nos. 5,673,647, 6,000,361, 6,135,055, 6,318,289, add 6,516,746, issued over several years to Pratt, entitled “Cattle Management Method and System”.

Although electronic identification through radio frequency identification (RFID) tags or barcodes are used in some phases of the livestock production cycle, all of these devices are designed to operate with the livestock in a confined location such as a coral or feedlot. There is a need to provide a means for automated individual animal identification in an open range and throughout the production cycle in order to maximize the capability of source verification and minimize the difficulty of data entry and data retrieval as well as making the information easily available to multiple individuals or groups throughout the industry.

At different stages of the production cycle, there are different databases, which exist for different business purposes. The livestock producer will typically maintain his own database, a stockman will have an inventory system, a feedlot will have a management database, and a packer will have its own inventory and management system. There is a trend toward larger marketing alliance and national databases that include some data from each of these industry segments.

U.S. Pat. No. 5,322,034, which issued Jun. 21, 1994 to Richard L. Willham, for a “Livestock record system” describes a method for storing the individual animal's identification and performance data on a programmable electronic identification and data storage module carried with the animal. An object of the present invention is to provide a low-cost per animal system for obtaining and maintaining source verification and performance databases that are independent of the animal and available to multiple individuals or groups not just those with access to the “data storage carried with the animal”.

U.S. Pat. No. 5,315,505 issued to William C. Pratt on May 24, 1994 for a “Method and system for providing animal health histories and tracking inventory of drugs” describes a method and system for providing improved drug treatment to selected animals in a retained group. A computer system is used to provide an operator with the health and drug treatment history of an animal. With this information and a diagnosis of the animal's health condition, a drug treatment is chosen. The diagnosis and treatment are entered into the computer system to update the animal's health and treatment history. An object of the present invention is to provide complete source verification and performance databases for all key livestock events including current biometric data as well as historical biometric data collected.

U.S. Pat. No. 5,673,647 for a “Cattle management method and system”, issued on Oct. 7, 1997 to William C. Pratt, describes an automated method and system for providing individual animal electronic identification, measurement and value-based management of cattle in a large cattle feedlot. That method includes individual animal identification, a computer system, and multiple measurements coupled with cattle handling and sorting system. An object of the Pratt patent was to build a feedlot database to more accurately identify and measure characteristics such as weight, so that subsequent animals could be produced and fed for more effective value-based selection and management of the animals. In particular, that database related to calculations for economic management of feeding and shipping to permit optimum weight gains and feedlot ship dates. Whereas the feedlot patent disclosed identifying a particular animal on arrival at the feedlot, an object of the present invention is to not limit the data collection to a feedlot, but track and collect data individual animals on an open range, corral, or feed lot throughout the entire production and processing cycle.

### BACKGROUND OF THE INVENTION

### Objects and Advantages

Accordingly, besides the objects and advantages of the open rang monitoring described in my above patent, several additional objects and advantages of the invention are:
a) to provide an automated daily record of the location of any animal being monitored allowing energy savings as a result of known location when that animal needs to be manually serviced;
b) to provide a complete printable record of the animal location during it's entire life cycle meeting the Country of Origin (COOL) requirements;
c) to provide an electronic tag that can poll an injected Radio Frequency Identification Device (RFID) and transmit that information to a satellite;
d) to provide a tag radio transmitter/radio frequency identification device (RFID) reader that has a battery or fuel cell as a power source;
e) to provide a tag that has a solar charger when the ear tag is battery powered;
f) to provide a tag that is powered from an external microwave source while near source, such as hand held RFID reader or chute side RFID reader;
g) to provide a tag with a re-usable electronic module that can be removed from the outer tag casing and inserted in a new tag casing to lower the cost of the system.

Further objects and advantages of the open range livestock asset management system are to provide automatic notification to the livestock owner if the animal is outside a predefined range, or biometric range set by the livestock owner. An automated information collection system that does not require the livestock owner to continuously manually record data, while providing historical individual animal data to stake holders not in the direct title chain. The additional capability of providing the livestock owner relevant information of rangeland capacities and alarm in an over grazing condition. Still further objects and advantages will become apparent from a consideration of the ensuing description and drawings.

### SUMMARY OF THE INVENTION

In accordance with the present invention a method that enables a livestock producer to monitor their livestock in an open range, to automatically collect individual animal data via a relay satellite link and to update that data into a globally assessable format over a public communications network. By using this system any animal may be tracked from its conception to its consumption, and its history will provide source verification, quality assurance, and performance tracking to multiple concerned individuals or groups that are allowed access to the data. The system is not limited to monitoring livestock in a corral or feedlot and does not require the livestock owner to invest in electronic infrastructure to take advantage of the system.

The primary objective of this invention is to provide an automated animal identification method and asset management system for those non-automated entities and persons involved in the production and processing of livestock that is available via a public network. The present invention allows those persons and entities to identify livestock animals with electronic identification units in the form of a radio frequency transponder reader contained within an active electronic identification radio frequency identification tag that collects information on that individual animal and communicate that information by a relay satellite to a hub collection and processing server for redistribution the information via a public network.

Another objective of the present invention allows for compatibility with existing livestock identification technologies so that these devices can continue to be used either independently or integrated within this information collection system.

An additional objective of the system is to provide automated monitoring of range and pastureland to prevent overgrazing conditions that lower the quality of the livestock and value of the range and pastureland for future grazing potential.

### BRIEF DESCRIPTION OF THE DRAWINGS

For a more complete understanding of the present invention and for further advantages thereof, reference is now made to the following description of the Preferred Embodiments taken in conjunction with the accompanying drawing in FIG. 1 is an Overall System Block Diagram of the present invention of Satellite Livestock Monitoring in an Open Range. This figure shows the components of the system including the electronic ear tag, relay satellite, communications hub, network connections, and network data entry and display devices.

FIG. 2 shows the preferred embodiment of the electronic module with the different electronic subsystems of the electronic tag device.

FIG. 3 presents the tag external features and the location the tag as attached to the animal, as well as the radio frequency identification device (RFID) being implanted in the animal or being contained in the ear tag device itself.

FIG. 4 illustrates a typical data entry form where individual animal information may be added to the information collected automatically by the livestock owner using a personal computer with Internet connectivity.

FIG. 5 represents a graphical image such as would be available to the livestock owner while utilizing a standard communication network interface display such as a Web browser, showing the location of an animal along with its unique identification number and biometric data.

FIGS. 6A to D illustrates various aspects of the electronic livestock satellite radio tag with a removable internal electronic module and how the internal electronic module can be inserted into a new tag casing and later removed for re-utilization.

### DRAWINGS—REFERENCE NUMERALS

10 network connections (Internet)
12 relay satellite
14 electronic ear tag
16 satellite communication hub and network access
18 personal computer
20 personal data unit (PDA)
22 cellular phone
24 radio frequency identification device (RFID)
26 satellite transmitter/receiver
28 global positioning receiver (GPS)
30 solar collection panel
32 battery
34 externally excited power sensor/source
36 memory and central processor unit
38 radio frequency identification device reader
40 ear tag external casing
42 ear tag fastener
44 ear tag electronics module
46 visual identification number
50 solar panel
52 embedded satellite antenna
54 solar panel to electronic module connector
56 satellite antenna to electronic module connector
58 unsealed end of new ear tag
60 graphical representation of range
62 latitude and longitude of animal
64 current range food capacity indicator
66 scale of graphic representation
68 identification and biometric representation of a single animal
70 warning message box
71 Typical electronic data entry form

### DESCRIPTION OF THE PREFERRED EMBODIMENTS

With reference to the drawing in FIG. 1 the Overall Block Diagram form of the electronic identification tag system. The electronic radio frequency identification device (RFID) reader 38 within the electronic module of the animal tag 14 polls the radio frequency identification device (RFID) 24 for unique identification number and current biometric data information 40 and stores the information in the processing unit 36 of the animal tag 14 along with the current location and time received from the GPS receiver 28. The animal tag 14 satellite transmitter 26 then transmits the animals unique identification number, location, biometrics and time information last stored to the satellite 12 which relays that information to the network hub 16. The network hub collects the information and stores it in an electronic record on a data server. Software at the hub automatically saves the electronic record to the associated livestock owner's records and appends those electronic records with the updated information. The updated electronic data records are then made available to a public network 10 for access by the livestock owner or other stakeholders via personal computers 18, cell phones 22, or personal data units 20 with network access capabilities and rights. All data records from the network hub 16 will be available via a Web browser or other network graphic user interface form to users that are connected to the network and have access rights to the data.

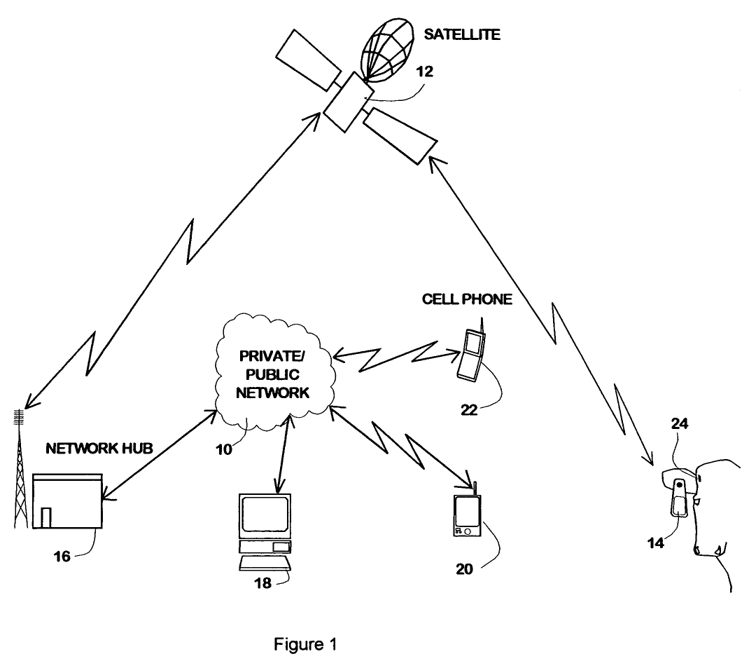

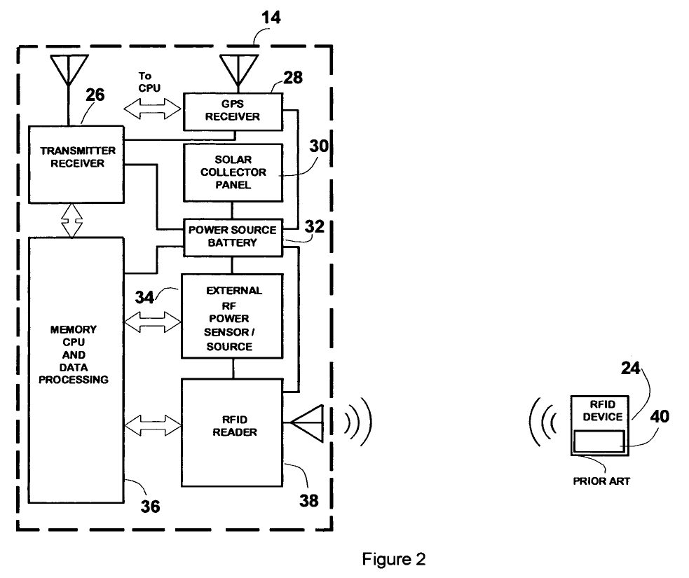

FIG. 2 shows the basic components of the removable electronic module and that it contains the satellite transmitter 26, the global positioning satellite receiver (GPS) 28, a data processing central processor unit (CPU) and memory subsystem 36, external radio frequency field sensing power source 34, and the radio frequency identification device (RFID) reader 38, which may be any type of radio frequency reader, but for reasons given herein, this invention is particularly useful for passive RFID devices that may be implanted under the skin of the livestock animal. The electronic module 44 is supplied with operating power by electrical power by electrical power supply 32, or the external radio frequency field sensing power source 34. The electrical supply system will be in one form that can be recharged during daylight by a solar power source 30. The system conserves battery power by only reading the RFID device 24 and the GPS receiver 26 data periodically or when triggered by an event such a preprogrammed clock time or from the satellite transmitter 26 when polled.

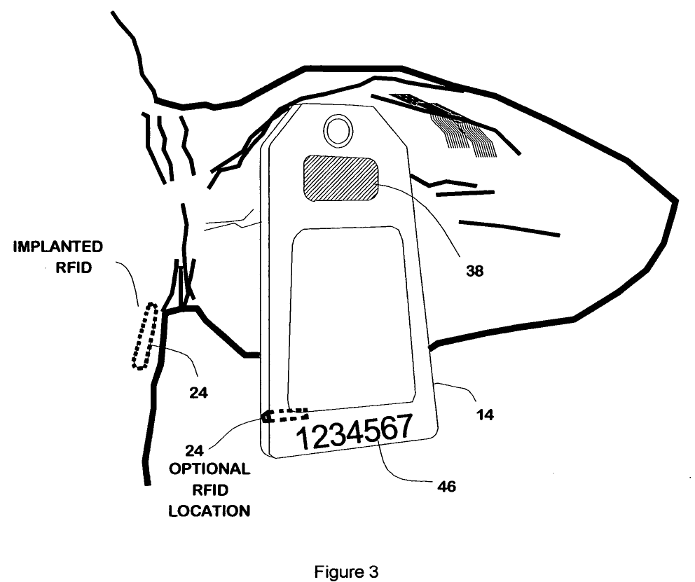

In FIG. 3 according to this invention a Global Positioning (GPS) Receiver 28 is integrated into the electronic identification tag system. The GPS 28 collects information such as latitude, longitude, and time, which is stored in the CPU/memory and data processing unit 36. The information data is combined with other data collected from the RFID 24 and transmitted to the satellite when triggered by a request from the satellite or at a time scheduled by the CPU 36. The GPS 28 receiver will also provide a high stability reference source that is utilized by the transmitter 26 to maintain a highly stable frequency that allows for higher reliability of the communications link with the satellite 12.

According to this invention a set of biometric sensors 40 are integrated into the RFID 24. The biometric detectors collect data such as heart rate, temperature, and blood pressure periodically and that information is stored in the memory location 36 when the RFID 24 device is polled by the RFID reader 38. The biometric information may be of any type that may be available. The RFID device is available from several sources and device functions and capabilities are expected to change in the future. The CPU 36 will easily be re-programmed for features as they are added by the RFID 24 manufactures.

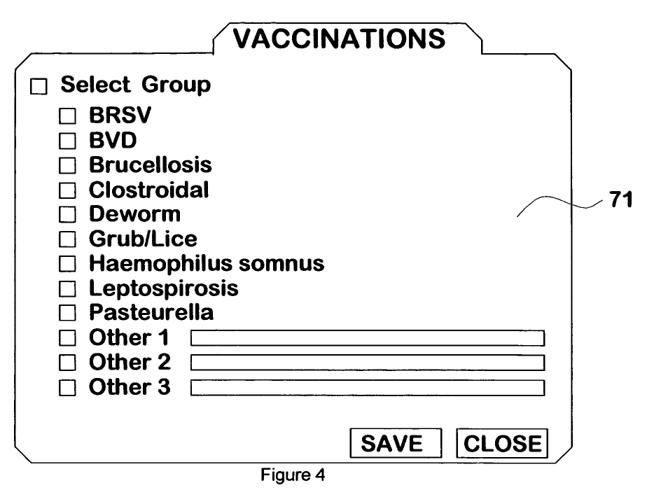

FIG. 4 illustrates the preferred form of the invention with the identification tag indicating visually a unique identification number 46 that is electronically linked to a specific electronic data record and unique identification number of the RFID 24. The RFID chip 24 is shown in FIG. 4 as being optionally mounted in the external tag casing 40 or implanted under the livestock animals' skin. Either method will work with this invention, but the preferred method is that the RFID device 24 is implanted since this method is more tamper resistant and can stay with the animal for its entire production cycle with a low possibility of being removed from the animal by accident. The actual method utilized may be determined by the livestock owners' preference.

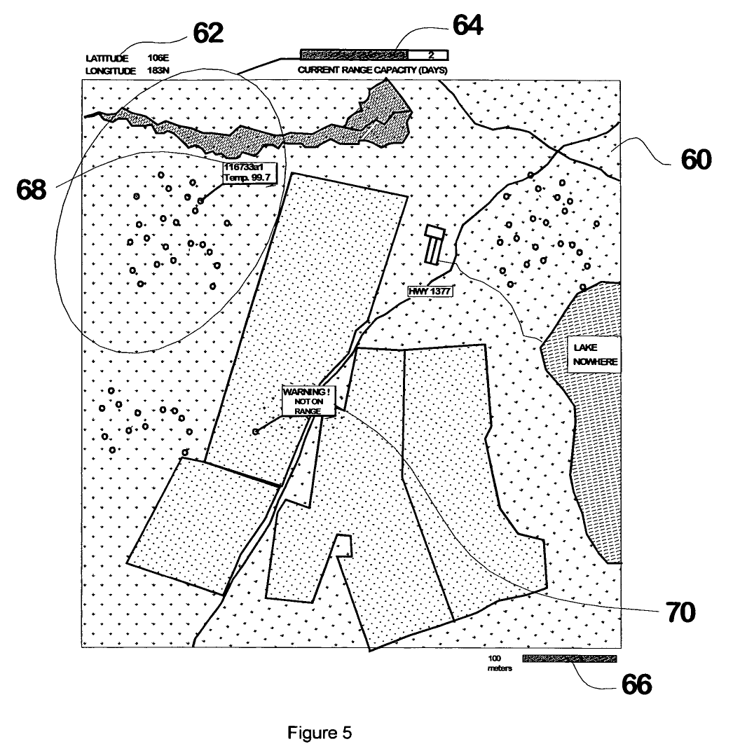

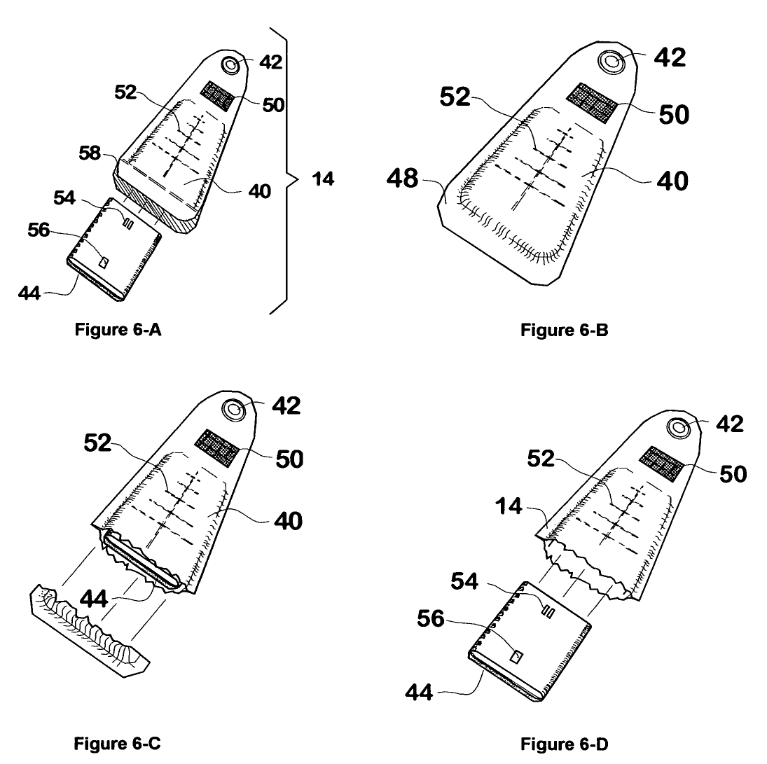

FIG. 5 illustrates a typical GUI interface that the livestock owner will use to locate specific information about an individual animal. The livestock owner would access a map of his location 60 and request that all animals being tracked within the selected group are displayed 64. By entering a specific individual animal or group of individual animals the graphic user interface would update and highlight information specific to those animals. The livestock owner would then select one of the highlighted animals and open the current detailed data record for that animal 68. All historical data such as sex, lineage, vaccinations, and feeding records as well as current records for location and biometric data will be easily accessed.

The livestock owner can choose to manually modify the data record of the individual animal or group of animals by updating the database record with new information such as new feed type or recent vaccinations. The electronic data record is verified and then updated at the network hub server. The updated information would also be available over the network to other individuals or groups that may have an interest and as well as the access rights to that animal or group of animal records.

With reference to FIG. 2A to 2D the electronic satellite transmitter receiver/RFID reader animal tag 14 consists of a lightweight plastic outer shell 40, removal electronic module 44, and solar collector 50. FIG. 2A illustrates a new tag shell 40 and electronic module 44 prior to the electronic module 44 being inserted into the tag casing 40. This figure also indicates the solar collector connector 54 and the satellite antenna connector 56 on the electronic module. FIG. 2B shows a completed ear tag 14 with end sealed 48 and ready to be attached to a herd animal. FIG. 2C shows the tag casing 40 with the end cut off for access to the electronic module 44. FIG. 2D shows the empty used electronic tag casing 40 and the electronic module 44 removed and ready to be reused in a new tag casing not shown. All FIGS. 2A to 2D illustrate the solar collector 50 and the embedded satellite antenna 52.

1. A method of monitoring a livestock animal via a relay satellite, the method comprising the steps of:
attaching a radio frequency identification device (RFID) system to the livestock animal;
obtaining by the RFID system specific data on the livestock animal;
transmitting by the REID system the specific data to the relay satellite;
relaying the specific data from the relay satellite to a network hub communicating with a data server; and
storing the specific data in the data server.

2. The method of monitoring a livestock animal of claim 1 further comprising the step of obtaining the specific data from the data server.

3. A method for automatic, semi automatic and manual entry of data into an integrated electronic information base for livestock management and data collection comprising;
automated electronic registration form which includes fields for the date and time, latitude and longitude location of the individual livestock animal, time tagged monitored biometric reading of individual, livestock animal, identification code that has been assigned to the livestock producer,
semi-automatic entry of electronic registration, by selecting a common group of characteristics applied to an individual animal or group of animals, adding data records for a group of animals to a larger group of animals, moving a group of animal data records from a larger group to a sub-group or to different group,
a manual entry of electronic registration form for entering the billing address for the registering livestock manager, billing phone number for the registering livestock manager, all contact and location telephone numbers for the registering livestock owner or organization, all electronic mail, cell phone, or personal data assistant numbers or electronic addresses for automated event notification, and the contact person(s) at the site where the animal is located.

4. A means for claim 3 for of manual and semi automatic data entry into an integrated database for livestock management and data collection consisting of;
assigning an individual livestock group and individual identifier with subgroup identifiers, and
providing networked access to at least one animal electronic data record, said animal electronic data record containing data fields in which characteristics specific to an individual animal which may be automatically/semi automatically/or manually recorded on the animal electronic data record;
a livestock producer entity identification means for identifying a livestock producer location with an individual or group of animals within the data collection software;
completing an electronic registration form whereby a non-automated livestock producer is enrolled into an automated system, said electronic registration form containing fields for identifying information and contact information for said livestock producer;
processing the electronic registration form through an electronically networked processing data server; assigning an electronic livestock producer identification code to each livestock producer location being registered, thereby identifying a livestock producer with a livestock producer identification code,
automatically applying the numeric code for the livestock producer to the corresponding registration electronic data,
completing an electronic data record by supplying pertinent information on a particular animal, said data record having a unique animal identification numeric code for identifying the animal.

5. A means of asset management wherein the electronic data record includes fields for the complete information of the individual livestock animal consisting of;
the ranch/farm or on which the animal is located,
visual identification tag number for the animal,
animal's sex,
brand,
method and dosage of medications and vaccinations,
all feeding records including type, brand, and source
all treatments a particular animal underwent,
animal's frame rated as 1-10, animal's health condition rated as 1-10, animal's breed,
sire or dam code as such code is defined by the electronic data record,
animal's birth date,
animal's color,
animal's weight at a time tagged date,
pregnancy checks performed on the animal,
user configurable records as needed to define a characteristic of an individual animal or group,
miscellaneous notes as applicable to an individual animal that may be recorded for future reference.

6. The method of claim 5 wherein entering and storing the information from each animal's electronic data record into an integrated electronic database includes the steps of;
manually entering information on individual animal over an electronic network data entry device such as a computer terminal connected to the Internet,
entering information on individual animal over an electronic network with a handheld networked device,
verifying that the livestock producer identification code has been assigned and stored in data collection software program,
entering and storing the information from each data record into a data collection software program,
a group of information electronic worksheets for recording characteristics common to the group of animals.

7. A means of graphically displaying range land location and individual animals within that area consisting of;
graphical representation of area of interest that can be re-scaled as required by using a network browser interface,
longitude, latitude, and any biometric information of each animal displayed when selected by graphic pointing device,
additional informative information displayed as may be available.

8. A method in claim 7 of predicting range land capacity and generating a warning message of an over grazing condition consisting of;
stored reference data of the environmental conditions of range land; and
an algorithm that compares the capacity against the number of animals and the amount of time animals are within grazing area to determine available food source;
dynamically scalable electronic map accessible over the network by a display device such as a personal computer, or personal data unit connected to the network of the location of the animal(s) in the electronic data records maintained by the livestock owner displaying pasture physical representation and current grazing capacities that automatically track the available resource based on number of animals and duration of animals in the pasture along with historical grazing capabilities definable by default for the specific geographical area and modifiable by the livestock owner with local knowledge increase or decrease of capacity.

9. The means of asset management in an open range wherein the individual animal has a visual and electronic identification tag consisting of;
an electronic identification outer shell with visual identification number on the tag shell,
an active data processing and memory section,
a radio frequency identification device transponder reader,
an active satellite transmitter tag device which provides a unique electronic identification code when transmitting or is queried by a satellite radio frequency source and that code identifies a particular animal,
an electronic identification tag that is a battery powered electronic tag device with external visual numeric code,
an electronic identification tag that includes solar powered battery recharge capabilities,
an individual animal identification tag that collects and stores data from an radio frequency identification device with unique identification number and biometric information of the animal such as may be available,
an electronic identification tag that contains a global positioning sensor and utilized as a frequency stability source for the satellite and also provides additional information for the individual animal data record for automatic data collection which includes latitude, longitude, time of data record collection,
automatic periodic transfer of stored data from the electronic identification tag to the information collection hub server via a relay satellite where the animal's unique identification and data is stored into an integrated electronic file,
an electronic identification tag transmitter that will also transmit when exposed to a microwave field such as those found in existing chute or hand scanners,
an electronic transmitter frequency that will automatically change to match reader devices currently in use when exposed to such microwave field,
an electronic tag battery will be disabled when exposed to such microwave fields,
an electronic tag will store latitude, longitude, date an time information when exposed to such microwave field,
an electronic tag will transmit to satellite data stored during exposure to external microwave field to network hub server during next communications link.

10. A means of removing and replacing of the electronic identification tag electronic subsystem and placing those electronics into new electronic tag shell consisting of;
an electronic plastic shell with hollow interior that holds an electronic tag electronic module subsystem,
an electronic tag shell with imbedded solar collector and satellite communications antenna that mate with electronic module when inserted into the hollow tag shell,
an electronic tag shell that is permanently sealed after the electronic tag module is inserted,
an electronic tag shell that has marking indicators where tag can be cut open and electronic module removed,
an electronic tag electronic module that has removable replaceable power source,
an electronic tag electronic module that has connector fittings for solar collector and satellite antenna that are imbedded into the electronic tag plastic shell.

11. The method of monitoring a livestock animal of claim 2 wherein the step of obtaining the specific data from the data server includes accessing the data server via a public network.

12. The method of monitoring a livestock animal of claim 1 wherein the step of transmitting the specific data to the relay satellite includes automatically transmitting the specific data at a predetermined time period.

13. The method of monitoring a livestock animal of claim 1 wherein:
the RFID system includes a locating device for obtaining the location of the livestock animal; and
the specific data includes the location of the livestock animal.

14. The method of monitoring a livestock animal of claim 1 wherein the step of obtaining by the RFID system specific data on the livestock animal includes obtaining biometric readings of the livestock animal from a biometric detector.

15. The method of monitoring a livestock animal of claim 1 wherein the step of attaching a radio frequency identification device (RFID) system on the livestock animal includes affixing an electronic identification tag to the livestock animal, the electronic identification tag providing a unique identification number for identifying a specific livestock animal.

16. The method of monitoring a livestock animal of claim 15 wherein the RFID system includes a RFID chip mounted within the electronic identification tag affixed to the livestock animal.

17. The method of monitoring a livestock animal of claim 1 wherein the RFID system includes a RFID chip implanted under the skin of the livestock animal.

18. The method of monitoring a livestock animal of claim 1 wherein:
the step of transmitting by the RFID system the specific data to the relay satellite includes automatically transmitting the specific data at a set time period frequency; and
the step of storing the specific data in a data server includes the step of automatically compiling the specific data of the livestock animal with a plurality of other livestock animals.

19. The method of monitoring a livestock animal of claim 1 further comprising the step of modifying the specific data by a user within the data server.

20. A system for monitoring a livestock animal, the system comprising:
a radio frequency identification device (RFID) system attached to the livestock animal, the RFID system electronically identifying the livestock animal;
means for obtaining specific information on the livestock animal; and
means for transmitting the obtained specific information of the livestock animal to a relay satellite.

21. The system for monitoring a livestock animal of claim 20 further comprising:
a data server for storing and automatically compiling the obtained specific information of the livestock animal; and
a relay satellite for relaying the transmitted specific information to the data server.

22. The system for monitoring a livestock animal of claim 20 wherein the means for transmitting the obtained specific information of the livestock animal includes transmitting the obtained specific information automatically at a predetermined time period.

23. The system for monitoring a livestock animal of claim 20 wherein the means for obtaining specific information on the livestock animal includes a biometric detector for detecting a biometric reading of the livestock animal.

24. The system for monitoring a livestock animal of claim 20 wherein the obtained specific information stored in the data server is accessible via a public network.

25. The system for monitoring a livestock animal of claim 20 wherein the RFID system includes a global positioning satellite (GPS) receiver for determining the location of the livestock animal.

26. A system for monitoring a livestock animal, the system comprising:
a radio frequency identification device (RFID) system attached to the livestock animal the RFID system electronically identifying the livestock animal and obtaining specific information on the livestock animal;
a relay satellite;
a satellite transmitter for transmitting the obtained specific information of the livestock animal to the relay satellite; and
a data server;
whereby the relay satellite relays the transmitted specific information to the data server, the data server storing and automatically compiling the obtained specific information of the livestock animal.

27. The system for monitoring a livestock animal of claim 26 wherein the RFID system includes an electronic identification tag attached to the livestock animal, the electronic identification tag providing a unique identification number for identifying a specific livestock animal, the electronic identification tag being removable from the livestock animal and reusable with a second livestock animal.

28. The system for monitoring a livestock animal of claim 26 wherein the data server is accessible by a public network.
